(19) United States
(12) Patent Application Publication
(10) Pub. No.: US 2025/0300783 A1
(43) Pub. Date: Sep. 25, 2025

(54) APPARATUS AND METHODS FOR PHASE TRACKING IN SPACE TIME BLOCK CODES

(71) Applicant: Huawei Technologies Co., Ltd., Shenzhen (CN)

(72) Inventors: Nuwan Suresh Ferdinand, Kanata (CA); Huang Huang, Shenzhen (CN)

(21) Appl. No.: 19/213,739

(22) Filed: May 20, 2025

Related U.S. Application Data
(63) Continuation of application No. PCT/CN2022/133456, filed on Nov. 22, 2022.

(51) Int. Cl. H04L 5/00; H04L 27/26

(52) U.S. Cl. CPC H04L 5/0051; H04L 5/0023; H04L 27/2613

(57) ABSTRACT

Partitioning of data into data blocks and multiplexing a phase tracking reference signal (PTRS) with the data blocks provides a space time block coding (STBC) signal structure between pairs of the data blocks for transmission on respective antenna ports. Signaling that indicates parameters associated with the partitioning and multiplexing is communicated between communication devices in a wireless communication network, and the data blocks multiplexed with the PTRS are transmitted and/or received in the wireless communication network.

### CROSS-REFERENCE TO RELATED APPLICATION

This application is a continuation of International Application No. PCT/CN2022/133456, filed on Nov. 22, 2022, the disclosure of which is hereby incorporated by reference in its entirety.

### TECHNICAL FIELD

The present application relates generally to wireless communications, and more specifically to phase tracking in wireless communications systems that use space time block coding.

### BACKGROUND

There are several techniques to achieve transmit diversity with the use of multiple transmit antennas. If channel state information is available at a transmitter, then the transmitter can apply beamforming in order to gain transmit diversity. In this type of approach, the transmitter encodes (known as “precoding”) multiple data layers (i.e., data streams) by multiplying the data layers with a precoder matrix. An important aspect of this type of approach is that the precoding operation results in a linear combination of the layers.

For single-carrier (SC) waveforms, peak-to-average power ratio (PAPR) is an important property. SC waveforms may be preferred in applications that require low PAPR because SC waveforms generally exhibit lower PAPR than multi-carrier waveforms. Therefore, any transmit diversity scheme for an SC waveform should aim to retain the same PAPR as a single layer transmission. However, conventional transmit beamforming on multiple layers of SC-waveform signals increases the PAPR of SC waveform signals.

One approach to achieve transmit diversity involves space time block coding (STBC), in which an Alamouti code is applied over two different symbols, such as two consecutive discrete Fourier transform-spreading orthogonal frequency division multiplexing (DFT-s-OFDM) symbols. One disadvantage of this type of scheme is an orphan symbol problem where an even number of symbols is needed.

An alternative to STBC is space frequency block coding (SFBC), which performs space coding in frequency domain. SFBC can be applied in frequency domain over consecutive subcarriers. That is, the Alamouti code is applied in consecutive subcarriers. However, this approach breaks the time domain structure of STBC and results in higher PAPR.

Therefore, trivial usage of STBC or SFBC is not a good solution for SC waveforms to achieve transmit diversity.

One non-trivial approach to perform STBC for DFT-s-OFDM, which is an example of an SC waveform, is referred to as SC-SFBC. See R1-1704814, “UL diversity transmission for DFTsOFDM”, 3GPP TSG-RAN WG1 RAN1 #88b, Spokane, Washington, Apr. 3-7 2017. This approach retains the PAPR of the DFT-s-OFDM waveform and provides transmit diversity, in particular for frequency flat fading channels. However, this approach suffers under frequency selective channels, and when phase noise is present.

According to another approach that is referred to as Split-STBC, STBC can be applied in two consecutive symbols, or in one symbol with two virtual splits. See R1-1708583, “On UL diversity transmission scheme”, 3GPP TSG-RAN WG1 Meeting #89, Hangzhou, CN 15^{th}-19^{th} May 2017. With a(n) and b(n) n∈{0, M-1} denoting M length data sequences, a transmitter uses a(n) to generate a DFT-s-OFDM symbol and transmits it using a first antenna, and a second antenna at the same time slot transmits a DFT-s-OFDM symbol generated from a conjugated time reversal version of b(n), which is denoted by b(−n)* and obtained using modulo operation, such that b(−n)*=b(mod(−n, M))*. In the next time slot, the first antenna transmits b(n) and the second antenna transmits −a(−n)*=−a(mod(−n, M))*. Alternatively, the transmitter may use a 2M length sequence [a(n) b(n)] to generate a DFT-s-OFDM symbol and transmit it using the first antenna and in the same time slots the second antenna transmits a DFT-s-OFDM symbol based on 2M length data sequence [b(−n)*−a(−n)* ]. In this approach, a receiver virtually splits these two 2M length sequences to achieve the same result as the previous case outlined above.

Although the Split-STBC approach may perform well under frequency selective channels, it suffers if there is a variation in time domain. When phase noise is present, this scheme severely suffers because two symbols are encountering different phase noise.

Also, with STBC, it is necessary to transmit the same symbol twice in two time instants. If phase tracking is implemented by trivially adding a phase tracking reference signal (PTRS) in STBC for example, then that same PTRS is repeated elsewhere in another time instant. When there is phase noise, the PTRS and its repeated versions are encountering different phase noise effects, and therefore phase noise estimation is inferior because conventional phase noise estimation would be based on an incorrect assumption that phase noise is the same for the two symbols.

Providing transmit diversity with low PAPR for SC waveforms remains a challenge.

### SUMMARY

Some embodiments disclosed herein provide transmit diversity for SC waveforms such as DFT-s-OFDM and single carrier offset quadrature amplitude modulation (SC-OQAM). Low PAPR of a single antenna SC waveform can be retained, or substantially retained at the same level, and enable a waveform to be used for accurate phase noise estimation and correction.

According to an aspect of the present disclosure, a method involves communicating signaling that indicates parameters associated with partitioning data into data blocks and multiplexing a PTRS with the data blocks such that the data blocks include at least one pair of data blocks for transmission on respective antenna ports to provide an STBC signal structure. Each pair of data blocks includes a first data block and a second data block. The STBC signal structure includes the first data block for transmission on a first antenna port and the second data block for transmission on a second antenna port, a next data block for transmission on the first antenna port being related to the second data block, and a next data block for transmission on the second antenna port being related to the first data block. The STBC signal structure also includes a first block of the PTRS at an end of each of the first data block and the next data block for transmission on the first antenna port, and a second block of the PTRS at an end of each of the second data block and the next data block for transmission on the second antenna port.

In an embodiment, communicating the signaling is by a first communication device with a second communication device in a wireless communication network, and the method also involves transmitting, in the wireless communication network by the first communication device, the data blocks multiplexed with the PTRS.

Another embodiment involves communicating the signaling with a first communication device by a second communication device in a wireless communication network. In such an embodiment a method may also involve receiving, by the second communication device, the data blocks multiplexed with the PTRS.

An apparatus according to another aspect of the present disclosure includes a processor and a non-transitory computer readable storage medium that is coupled to the processor. The non-transitory computer readable storage medium stores programming for execution by the processor. A computer program product may be or include such a non-transitory computer readable medium storing programming. Such apparatus may be implemented in a system.

In an embodiment, the programming includes instructions to or to cause the processor to communicate, with a second communication device in a wireless communication network, signaling that indicates parameters associated with partitioning data into data blocks and multiplexing a PTRS with the data blocks such that the data blocks include at least one pair of data blocks for transmission on respective antenna ports to provide an STBC signal structure; and transmit, in the wireless communication network by the first communication device, the data blocks multiplexed with the PTRS.

In another embodiment, the programming includes instructions to or to cause the processor to communicate, with a first communication device in a wireless communication network, signaling that indicates parameters associated with partitioning data into data blocks and multiplexing a PTRS with the data blocks such that the data blocks include at least one pair of data blocks for transmission on respective antenna ports to provide an STBC signal structure; and receive the data blocks multiplexed with the PTRS.

In these embodiments, each pair of data blocks includes a first data block and a second data block, and the STBC signal structure includes the first data block for transmission on a first antenna port and the second data block for transmission on a second antenna port, a next data block for transmission on the first antenna port being related to the second data block, and a next data block for transmission on the second antenna port being related to the first data block. The STBC signal structure also includes a first block of the PTRS at an end of each of the first data block and the next data block for transmission on the first antenna port, and a second block of the PTRS at an end of each of the second data block and the next data block for transmission on the second antenna port.

A method according to another aspect of the present disclosure involves: communicating, by a first communication device with a second communication device in a wireless communication network, signaling that indicates parameters associated with partitioning data into data blocks and multiplexing a PTRS with the data blocks such that the data blocks include at least one pair of data blocks for transmission on respective antenna ports to provide an STBC signal structure, and each pair of data blocks includes a first data block and a second data block; transmitting, by the first communication device, the data blocks multiplexed with the PTRS; and receiving, by the second communication device, the data blocks multiplexed with the PTRS. As in other embodiments, the STBC signal structure includes: the first data block for transmission on a first antenna port and the second data block for transmission on a second antenna port, a next data block for transmission on the first antenna port being related to the second data block, and a next data block for transmission on the second antenna port being related to the first data block, and the STBC signal structure further includes: a first block of the PTRS at an end of each of the first data block and the next data block for transmission on the first antenna port, and a second block of the PTRS at an end of each of the second data block and the next data block for transmission on the second antenna port.

The present disclosure encompasses these and other aspects or embodiments.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 is a simplified schematic illustration of a communication system.

FIG. 2 is a block diagram illustration of the example communication system in FIG. 1.

FIG. 3 illustrates an example electronic device and examples of base stations.

FIG. 4 illustrates units or modules in a device.

FIG. 5 is a plot illustrating phase noise estimates versus data symbol index.

FIG. 6 is a block diagram illustrating a time domain data structure according to an embodiment.

FIG. 7 is a block diagram illustrating an example transmitter according to an embodiment.

FIG. 8 is a block diagram illustrating a pair of data blocks and next data blocks for transmission on respective antenna ports.

FIG. 9 is a block diagram illustrating an example receiver according to an embodiment.

FIG. 10 is a block diagram illustrating a j^{th} pair of input data blocks according to an Example 1.

FIG. 11 is a block diagram illustrating the j^{th} pair of input data blocks of Example 1 with multiplexed PTRS blocks.

FIG. 12 is a block diagram illustrating a j^{th} pair of input data blocks according to an Example 2.

FIG. 13 is a block diagram illustrating the j^{th} pair of input data blocks of Example 2 with multiplexed PTRS blocks.

FIG. 14 is a block diagram illustrating a j^{th} pair of input data blocks according to an Example 3.

FIG. 15 is a block diagram illustrating the j^{th} pair of input data blocks of Example 3 with multiplexed PTRS blocks.

FIG. 16 is a block diagram illustrating a j^{th} pair of input data blocks according to an Example 4.

FIG. 17 is a block diagram illustrating the j^{th} pair of input data blocks of Example 4 with multiplexed PTRS blocks.

FIG. 18 is a block diagram illustrating a j^{th} pair of input data blocks according to an Example 5.

FIG. 19 is a block diagram illustrating the j^{th} pair of input data blocks of Example 5 with multiplexed PTRS blocks.

FIG. 20 is a block diagram illustrating a j^{th} pair of input data blocks according to an Example 6.

FIG. 21 is a block diagram illustrating the j^{th} pair of input data blocks of Example 6 with multiplexed PTRS blocks.

FIG. 22 is a signal flow diagram for uplink communications according to an embodiment.

FIG. 23 is a signal flow diagram for uplink communications according to another embodiment.

FIG. 24 is a signal flow diagram for downlink communications according to an embodiment.

FIG. 25 is a signal flow diagram for sidelink communications according to an embodiment.

FIG. 26 is a signal flow diagram for sidelink communications according to another embodiment.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

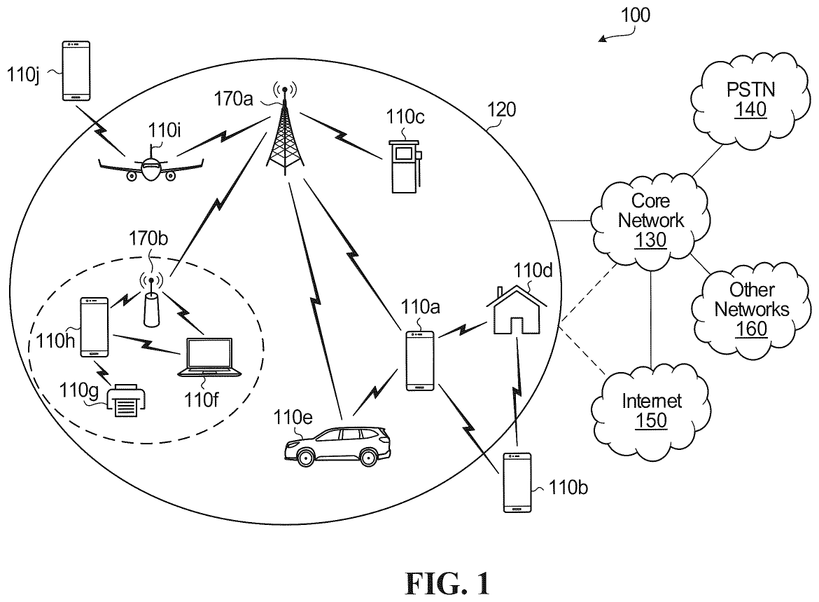

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. The electric device can be a terminal device or user equipment (UE). A core network 130 may be a part of the communication system and may be dependent or independent of the radio access technology used in the communication system 100. Also the communication system 100 comprises a public switched telephone network (PSTN) 140, the internet 150, and other networks 160.

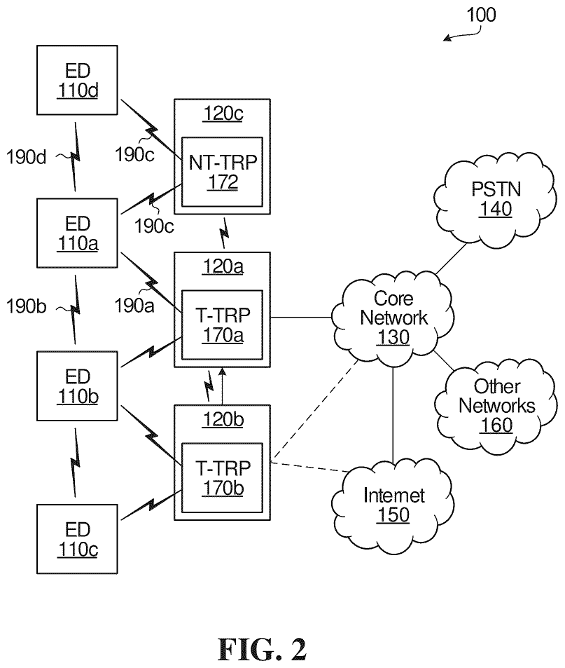

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such technologies.

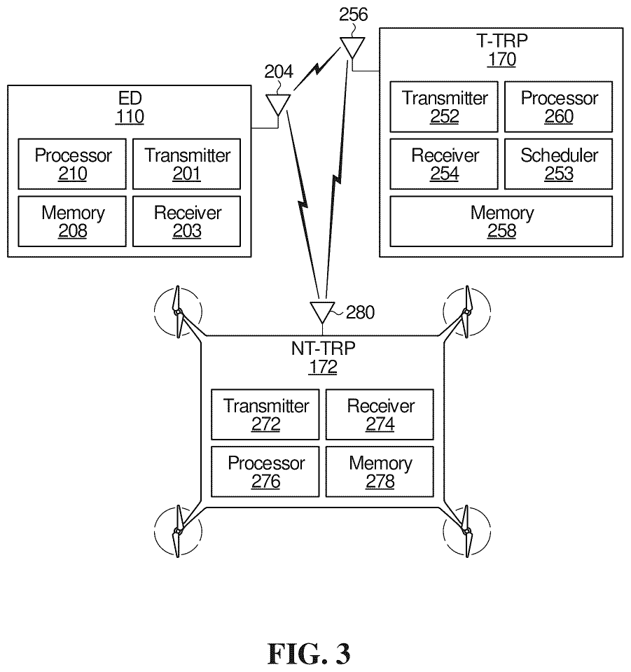

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

The T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

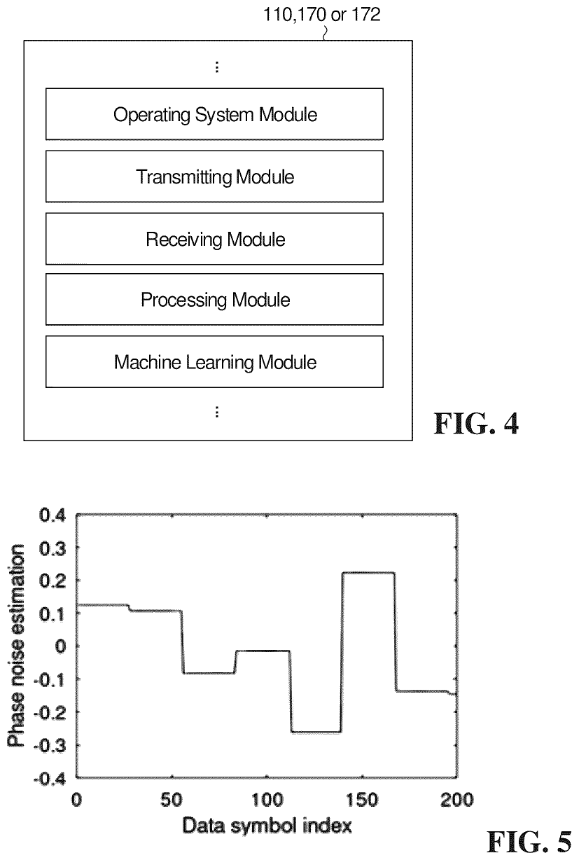

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

Having considered communications more generally above, attention will now turn to particular example embodiments.

The present disclosure encompasses embodiments that are applicable in deployments that include transmitters with multiple antennas to achieve transmit diversity gain. Illustrative and non-limiting example use cases or applications include any of uplink transmissions or communications to network devices such as base stations from EDs such as UEs, downlink transmissions or communications from network devices to EDs, and device-to-device transmissions or communications such as sidelink transmissions or communications between EDs. Embodiments may be particularly useful when phase noise is present and low PAPR is desired.

One challenge in providing transmit diversity for an SC waveform is avoiding a significant increase in PAPR. An STBC-based approach may be preferred to achieve transmit diversity that can retain the same or substantially the same PAPR. However, the effect of phase noise brings additional challenges to STBC-based approaches. Some embodiments disclosed herein can better handle phase noise, and involve a PTRS approach that retains STBC time domain signal structure. This enables phase noise to be estimated using PTRS, which in turn enables phase noise to be corrected. Potential advantages of disclosed embodiments include transmit diversity, low PAPR, and implementation of PTRS for phase noise estimation and correction.

Phase noise is time correlated. Therefore, when phase noise is estimated in the time domain, PTRSs are included as blocks. These PTRSs enable the phase noise to be estimated, and this estimation together with interpolation may be used to correct phase noise. This is based on an underlying assumption that the correctable phase noise is substantially constant within a certain time period or across a number of nearby data symbols. This is graphically shown in FIG. 5, which is a plot illustrating phase noise estimates versus data symbol index, with nearest neighbor interpolation applied. In the example shown, phase noise is presumed to be constant across 25 data symbols, but this is an example only for illustration.

According to an embodiment, multiple STBC pairs are created within one time domain symbol. Each pair is within a time period over which phase noise is expected to remain constant, or at least sufficiently constant to allow the same phase noise estimate to be used for phase noise correction. This may also or instead be described as the pairs being within the same phase noise bin.

As an example, let w denote an input symbol vector of length L. The elements of w may be or include, for example, QAM or OQAM symbols. The input symbol vector w may contain PTRS symbols and data according to embodiments disclosed herein.

The input symbol vector w is partitioned into 2J=L/M data blocks as

w=[u(1), v(1), u(2), v(2), . . . , u(J), v(J)]

where odd index blocks are denoted by u(j), j∈{1, . . . , J} and even index blocks are denoted by v(j), j∈{1, . . . J}. Each data block u(j), v(j) represents a data vector of length M, and the n^{th} element of a j^{th} block can be denoted uₙ(j) and vₙ(j).

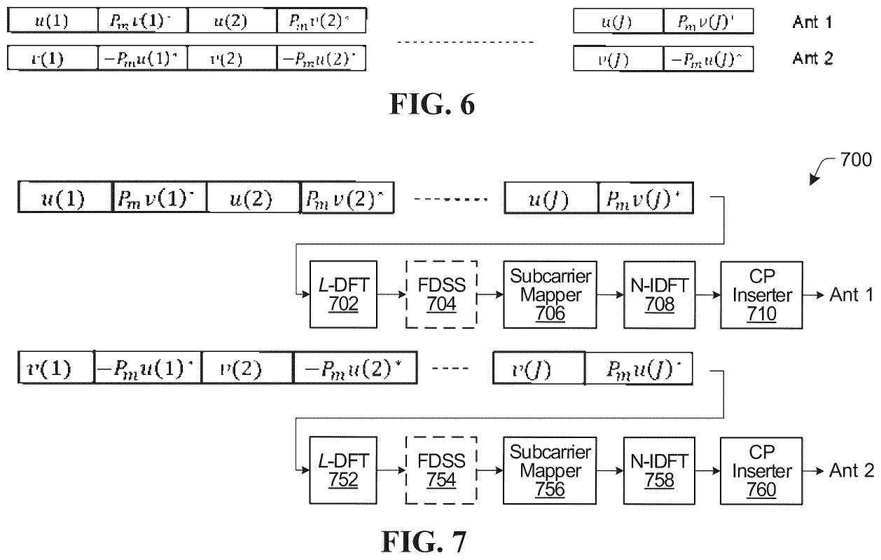

FIG. 6 is a block diagram illustrating a time domain data structure according to an embodiment. This data structure is an example of a data structure or a signal structure that is referenced herein as an STBC structure. The example in FIG. 6 is based on the input symbol vector w, and illustrates a sequence that is used in an embodiment to generate symbols for transmission by first and second transmit antenna ports, indicated by Ant 1, Ant 2 in the drawing.

Reference may be made herein to antennas, antenna elements, and antenna ports. An antenna port is defined such that the channel over which a symbol on the antenna port is conveyed can be inferred from the channel over which another symbol on the same antenna port is conveyed. For transmit diversity, different antenna ports are mapped to or otherwise associated with different antennas or antenna elements. Therefore, transmission of data blocks or symbols on an antenna port may also or instead be considered as transmission by, on, or via an antenna or antenna element.

FIG. 7 is a block diagram illustrating an example transmitter according to an embodiment. The example transmitter 700 includes a respective transmit chain for each of two antenna ports Ant 1, Ant 2, and each transmit chain in the example shown includes a DFT block 702, 752, a pulse shaper 704, 754 that applies frequency domain spectral shaping FDSS in the example shown, a subcarrier mapper 706, 756, an inverse DFT (IDFT) block 708, 758, and a cyclic prefix (CP) inserter 710, 760, interconnected as shown. Other embodiments may include additional, fewer, or different elements interconnected in a similar or different way. For example, a multiplexer may be provided in some embodiments to multiplex data and PTRS in time domain sequences that are input to the DFT blocks 702, 752.

The elements shown in FIG. 7 may be implemented in any of various ways, such as in hardware, firmware, or one or more components that execute software. The present disclosure is not limited to any specific type of implementation, and implementation details may vary between different devices, for example. Each of the elements in the example shown is configured, by executing software for example, to implement various features or operations.

Each DFT block 702, 752 is configured to convert from time domain to frequency domain by taking a DFT, and each optional pulse shaper 704, 754 is configured to pulse shape the frequency domain signal. Each subcarrier mapper 706, 756 is configured to map a respective (optionally) shaped frequency domain signal to subcarriers, and each IDFT block 708, 758 is configured to create a time domain signal by converting from frequency domain to time domain, in particular by taking an IDFT in the example transmitter 700. Each CP inserter 710, 760 is configured to insert a cyclic prefix (CP) prior to transmission.

The length L stream for transmission on each antenna port is provided as input to an L-DFT block 702, 752 for performing a DFT operation. Note that each partition or data block is of size M, but in the example shown they are considered as one data block for L-DFT. Optionally, after the DFT operation, frequency domain spectral shaping is performed using the FDSS block 704, 754. This operation performs pulse shaping, and it may be optional based on the waveform. The pulse shaped output (or DFT output) is mapped to subcarriers at 706, 756, and then an N-IDFT operation is performed at 708, 758 to generate a time domain symbol. The last step is to add a CP at 710, 760.

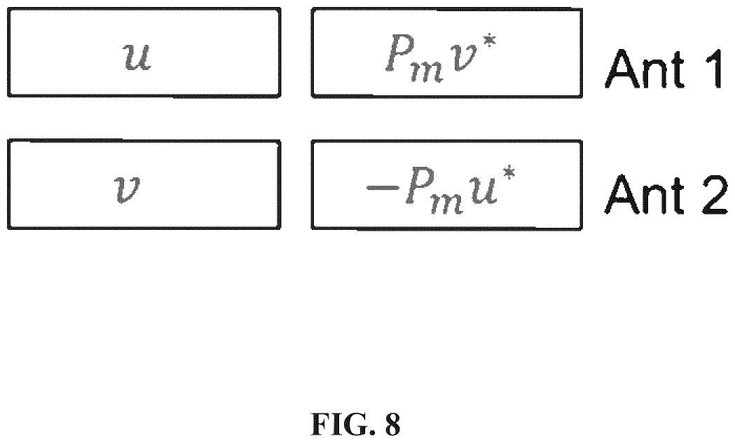

Consider now the data or time domain signal structure and different types of data blocks. As an example, a j^{th} pair of blocks includes corresponding data blocks u(j) and v(j). For ease of reference, the index j is not included below, and the two blocks in a data block pair are referenced as u and v. In a two-antenna port example, the input stream for Ant 1 includes a data block u of a data block pair and a next data block Pₘv*, and the input stream for Ant 2 includes a data block v of a data block pair and a next data block −Pₘu*, as shown in FIG. 8. The data structure in FIG. 8 is a generalized example of an STBC structure, with which the more detailed example in FIG. 6 is consistent.

The notation u* and v* in FIG. 8 denotes the conjugates of u and v, respectively. The notation Pₘ denotes a permutation matrix, such that the nth column of Pₘ is given by the [M−n+m−1]modM column of the identity matrix, where n, m∈{0,1 . . . , M−1}. Therefore, the n^{th} elements of Pₘu* and Pₘv* are

$${u}_{[ M - n + m - 1 ] modM}^{*} and n , m ∈ \{ 0 , 1 … , M - 1 \}$$

$${v}_{[ M - n + m - 1 ] modM}^{*} and n , m ∈ \{ 0 , 1 … , M - 1 \}$$

where the [·]mod M notation denotes the modulo operation.

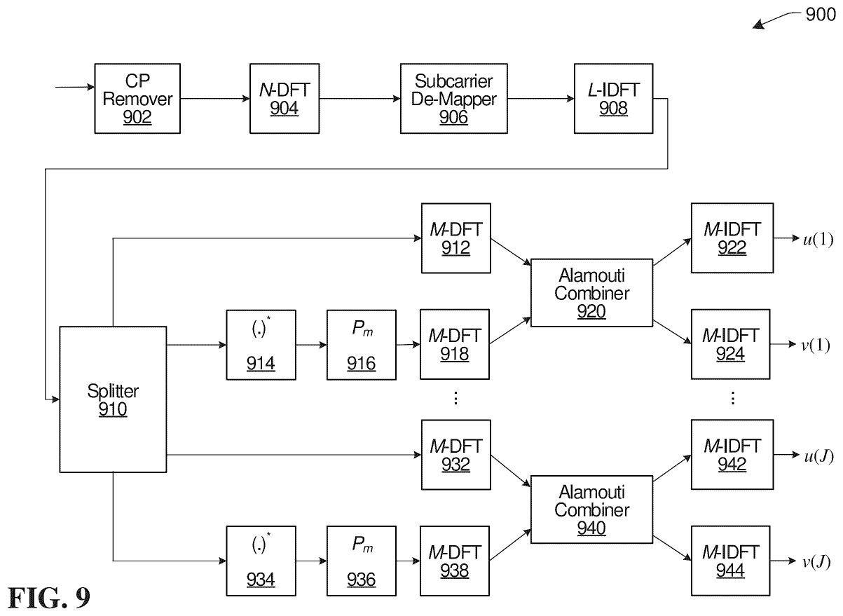

FIG. 9 is a block diagram illustrating an example receiver according to an embodiment. The example receiver 900 includes a CP remover 902, a DFT block 904, a subcarrier de-mapper 906, an IDFT block 908, a splitter 910, DFT blocks 912, 918, 932, 938, conjugation blocks 914, 934, permutation blocks 916, 936, Alamouti combiners 920, 940, and IDFT blocks 922, 924, 942, 944, interconnected as shown. Other embodiments may include additional, fewer, or different elements interconnected in a similar or different way. For example, a receiver may include or support pulse shaping if pulse shaping is used at a transmitter. A receiver may also or instead include a phase noise estimator and a phase noise compensator, for example, to estimate and compensate for phase noise based on PTRS blocks.

The elements shown in FIG. 9, like those in FIG. 7, may be implemented in any of various ways, such as in hardware, firmware, or one or more components that execute software. As noted elsewhere herein, the present disclosure is not limited to any specific type of implementation, and implementation details may vary between different devices, for example.

In the example receiver 900, each of the elements shown is configured, by executing software for example, to implement various features or operations. The CP remover 902 is configured to remove and discard a CP, and the DFT block 904 is configured to perform a DFT to convert a received time domain signal to frequency domain. The subcarrier de-mapper 906 is configured to split a time domain signal into 2J blocks, including/pairs of data blocks. The conjugation blocks 914, 934 and the permutation blocks 916, 936 apply conjugation and permutation, respectively. The DFT blocks 912, 918, 932, 938 are configured to perform a DFT to convert to frequency domain, the Alamouti combiners 920, 940 are configured to perform frequency domain combining, and the IDFT blocks 922, 924, 942, 944 are configured to perform an IDFT to convert from frequency domain to time domain.

Thus, in operation, a receiver removes the CP at 902, then performs an N-DFT operation at 904 to transform a received signal to the frequency domain. Then, a subcarrier de-mapping operation is performed at 906 to recover the desired data in the frequency domain. Next, an L-IDFT operation is performed at 908 to generate time domain symbols. A length L received symbol vector is then split to 2J blocks at 910, such that each block is of size M. Then, these blocks are paired as in the transmitter. Each pair is separately processed.

For a given block pair, an M-DFT operation is performed on the first block at 912, 932. For the second block, the conjugate of the second block, which is denoted by (·)*, is first generated at 914, 934; then the conjugate of the second block is multiplied by the same permutation matrix Pₘ at 916, 936 as in the transmitter; and an M-DFT operation is performed at 918, 938. Next, an Alamouti combination operation is performed at 920, 940 on each pair of symbols outputted from each pair of M-DFT blocks 912/918, 932/938. Lastly, after Alamouti combining, respective M-IDFT operations are performed at 922, 924, 942, 944 to generate the two data layers in this example.

Regarding Alamouti-based space time block coding, consider the j^{th} pair of blocks. The received first and second blocks after splitting at 910 are as follows:

$${y}_{1} = {H}_{1} u + {H}_{2} v + {n}_{1}$$

$${y}_{2} = {H}_{1} {P}_{m} {v}^{*} - {H}_{2} {P}_{m} {u}^{*} + {n}_{2}$$

where H₁ and H₂ are, respectively, channel gain of Ant 1 and Ant 2.

M-DFT of y₁ generates, in frequency domain

$${Y}_{1} = {Fy}_{1} = {FH}_{1} u + {FH}_{2} v + {Fn}_{1} = ( {FH}_{1} {F}^{H} ) Fu + ( {FH}_{2} {F}^{H} ) Fv + {Fn}_{1}$$

$${Y}_{1} = {Λ}_{{H}_{1}} U + {Λ}_{{H}_{2}} V + {N}_{1}$$

and M-DFT of y₂ (after conjugating and permuting y₂ by Pₘ) generates, again in frequency domain

$${Y}_{2} = {FP}_{m} {y}_{2}^{*} = F ( {P}_{m} {H}_{1}^{*} {P}_{m} ) v - F ( {P}_{m} {H}_{2}^{*} {P}_{m} ) u + FP {n}_{2}^{*}$$

$${Y}_{2} = {FH}_{1}^{H} v - {FH}_{2}^{H} u + FP {n}_{2}^{*}$$

$${Y}_{2} = ( {FH}_{1}^{H} {F}^{H} ) Fv - ( {FH}_{2}^{H} {F}^{H} ) Fu + {FPn}_{2}^{*}$$

$${Y}_{2} = {Λ}_{{H}_{1}}^{*} V - {Λ}_{{H}_{2}} U + {N}_{2}$$

wherein PₘH*₁Pₘ=H₁^{H}, and (·)^{H} denotes the Hermitian operator.

The examples above relate primarily to data partitioning and STBC data/signal structure. In some embodiments, PTRS is included with data. PTRS may be added as a form of prefix, for example, so that it can serve two purposes. One purpose is to act as a form of cyclic prefix to help mitigate inter-symbol interference (ISI) at a receiver. A second purpose is to enable estimation of phase noise.

As mentioned above, data and PTRS may be multiplexed into the input of a transmitter, which may be expressed as

w=[u(1), v(1), u(2), v(2), . . . , u(J), v(J)]

where, w is an L length sequence that is partitioned into 2J data blocks, with each data block being of size M. As also explained above, two data blocks of a pair of data blocks are arranged to provide or maintain a space time block coding signal structure. For generality, considering the j^{th} pair of blocks u(j) and v(j) but dropping the index j to simplify notation, u(j) and v(j) are denoted by u and v, and the nth element of each block is denoted uₙ and vₙ, respectively.

In some embodiments, PTRS is included as a block of size K, and each data block u and v in a pair of data blocks includes two PTRS blocks. Let c and d be K length PTRS blocks. The r^{th} element of each of c and d is denoted by cᵣ and dᵣ, respectively, where r∈{1, . . . , K}. The PTRS blocks c and d are included in the following fashion in u and v for r∈{1, . . . , K}, in an embodiment

$${u}_{m - 1 + r} = {d}_{r}$$

$${u}_{M - K + r} = {c}_{K - r}$$

$${v}_{m - 1 + r} = {c}_{r}^{*}$$

$${v}_{M - K + r} = - {d}_{K - r}^{*}$$

where m is a permutation parameter related to a permutation matrix Pₘ. In this way, u and v each have two PTRS blocks or symbols of a total length of 2K elements and the rest of the M−2K elements in each length M data block are data elements. In some embodiments, the PTRS block size and permutation parameter m have the following relationship:

$$m \leq M - 2 K .$$

The value of m determines or sets the position(s) or location(s), in an M sized data block, where PTRS blocks will be placed, as illustrated by way of example below.

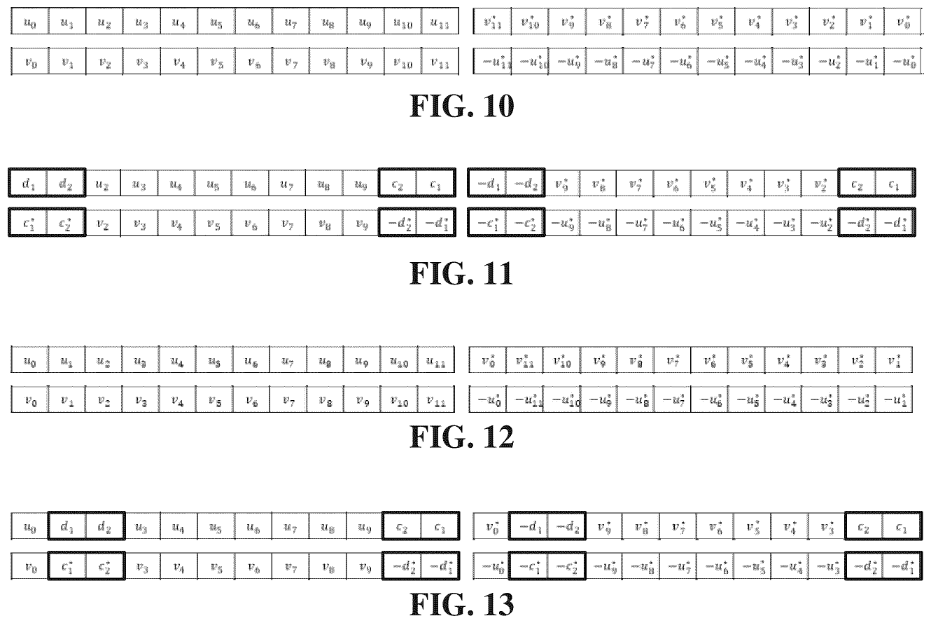

Consider an Example 1, with M=12 and m=0. FIG. 10 is a block diagram illustrating a j^{th} pair of input data blocks to a transmitter, after permutation, for Example 1. FIG. 11 is a block diagram illustrating the j^{th} pair of input data blocks of Example 1, but with multiplexed PTRS blocks. The PTRS blocks in FIG. 11, and in other drawings described below, are multiplexed with data based on the PTRS multiplexing criteria provided above.

In an Example 2, M=12 and m=1. FIG. 12 is a block diagram illustrating a j^{th} pair of input data blocks to a transmitter, after permutation, for Example 2, and FIG. 13 is a block diagram illustrating the j^{th} pair of input data blocks of Example 2 with multiplexed PTRS blocks.

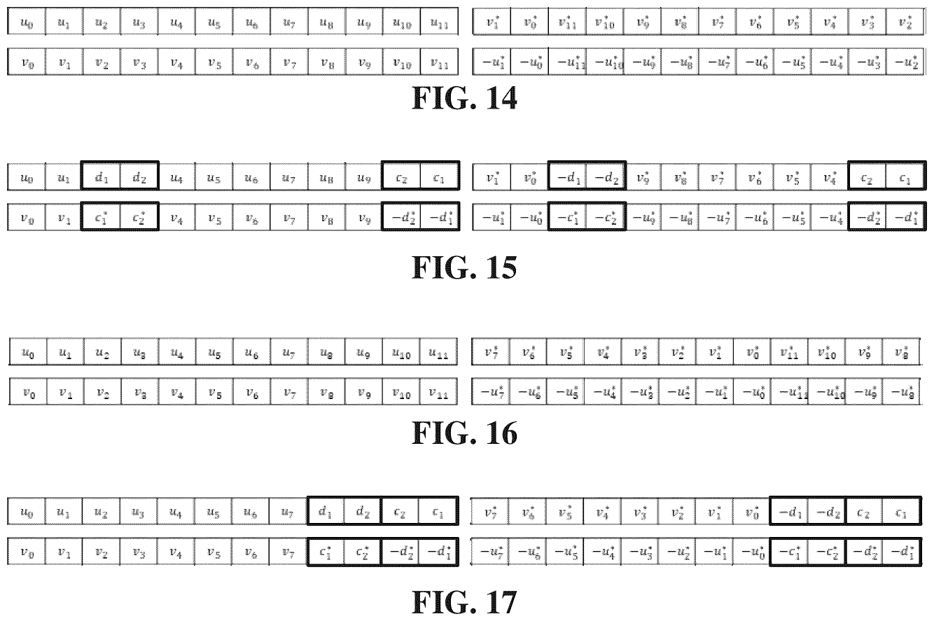

In an Example 3, M=12 and m=2. FIG. 14 is a block diagram illustrating a j^{th} pair of input data blocks to a transmitter, after permutation, for Example 3, and FIG. 15 is a block diagram illustrating the j^{th} pair of input data blocks of Example 3 with multiplexed PTRS blocks.

In an Example 4, M=12 and m=8. FIG. 16 is a block diagram illustrating a j^{th} pair of input data blocks to a transmitter, after permutation, for Example 4, and FIG. 17 is a block diagram illustrating the j^{th} pair of input data blocks of Example 4 with multiplexed PTRS blocks.

Comparisons between FIGS. 10, 12, 14, and 16, and between FIGS. 11, 13, 15, and 17 reveal the effect of different values of m, not only in permutations of input data blocks, but also in locations or positions of PTRS blocks.

Prefix PTRS blocks are added in Examples 1 to 4 such that the last set of PTRS blocks (denoted by c or d) in one data block are repeated in the last set of PTRS blocks of a next data block. With reference to FIGS. 11, 13, 15, and 17, for example, c₂ and c₁ of PTRS block c appear at the end of the first data block and the next data block for transmission by Ant 1, and −d₂ and −d*₁ of PTRS block d appear at the end of the first data block and the next data block for transmission by Ant 2. Therefore, the last part of the first block for transmission on each antenna port may be considered as being, or as providing an effect or feature of, a form of CP for a next data block.

PTRS blocks are preferably the same for all data blocks. That is, in the context of Examples 1 to 4, all data blocks preferably use c and d for “prefix” PTRS. That way, the prefix PTRS in one data block act as a form of CP for a next data block. In other words, prefix PTRS blocks (c and d) are the same for all data blocks for transmission on a pair of antenna ports, so that all data blocks have the same prefix.

This discussion of prefix PTRS is applicable to consecutive data blocks that are multiplexed with PTRS. In this case, for one data block, the previous data block's prefix acts, in effect, as a form of CP. However, there is a special case of the very first data block for transmission by an antenna port. A separate prefix may be used for that very first data block because there are no other data blocks before that data block. Therefore, the same prefix PTRS blocks (c and d) may be additionally added in front of the very first block. This can be a part of a traditional CP, for example.

Examples 1 to 4 and the example PTRS multiplexing criteria above may be referred to as prefix PTRS or PTRS prefix embodiments. In other embodiments, PTRS blocks are also or instead added as a form of cyclic postfix, instead of or in addition to prefix PTRS. PTRS added as postfix, like PTRS added as prefix, may help mitigate ISI and enable estimation of phase noise.

Consider an example in which PTRS is included as both prefix and postfix. Let the prefix PTRS block size be K₁ and the postfix PTRS block size be K₂. Each data block u and v in a pair of data blocks may include, for example, four PTRS blocks (two prefix PTRS blocks and two postfix PTRS blocks). With c and d denoting K₁ length prefix PTRS blocks and f and g denoting K₂ length postfix PTRS blocks, the r^{th} elements of c and d are denoted c, and d, where r∈{1, . . . , K₁}, and the r^{th} elements of f and g are denoted fᵣ and gᵣ where r∈{1, . . . , K₂}.

In an embodiment, prefix PTRS blocks are included in u and v for r∈{1, . . . , K₁} according to the following multiplexing criteria, consistent with the example criteria above but adjusted for K₁ instead of K

$${u}_{m - 1 + r} = {d}_{r}$$

$${u}_{M - {K}_{1} + r} = {c}_{{K}_{1} - r}$$

$${v}_{m - 1 + r} = {c}_{r}^{*}$$

$${v}_{M - {K}_{1} + r} = - {d}_{{K}_{1} - r}^{*}$$

and the postfix PTRS blocks are included in the following fashion in u and v for r∈{1, . . . , K₂}

$${u}_{m - {K}_{2} + r - 1} = {g}_{{K}_{2} + 1 - r}$$

$${u}_{r - 1} = {f}_{r}$$

$${v}_{m - {K}_{2} + r - 1} = {f}_{{K}_{2} + 1 - r}^{*}$$

$${v}_{r - 1} = - {g}_{r}^{*} .$$

Here, m is again a permutation parameter of the permutation matrix Pₘ. In this embodiment, the data blocks u and v each have 2(K₁+K₂) total length of PTRS blocks and the rest of the M−2(K₁+K₂) elements in each data block are data elements. In some embodiments, the PTRS block size and permutation parameter m have the following relationship

$$2 K \leq m \leq M - 2 K .$$

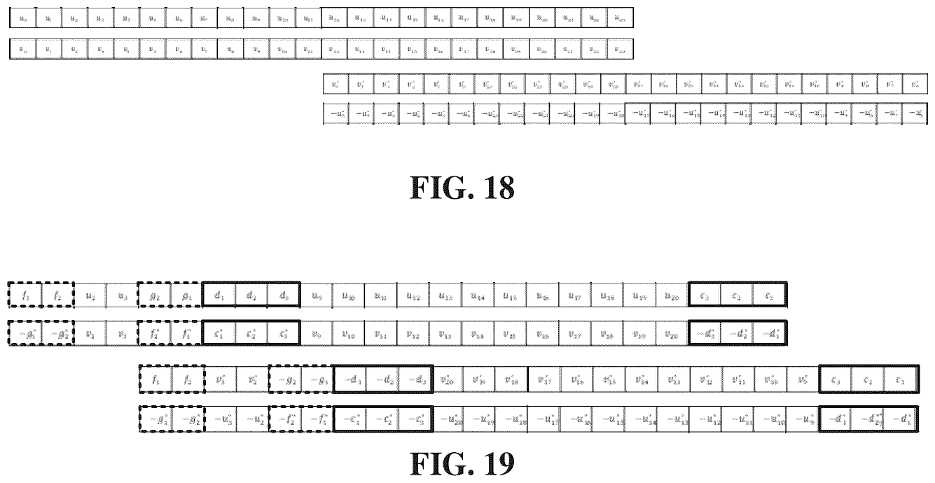

Consider now an Example 5, with M=24, m=6, K₁=3, K₂=2. FIG. 18 is a block diagram illustrating a j^{th} pair of input data blocks to a transmitter, after permutation, for Example 5. FIG. 19 is a block diagram illustrating the j^{th} pair of input data blocks of Example 5, but with multiplexed PTRS blocks. The PTRS blocks in FIG. 19, and in FIG. 21 described below, are multiplexed with data based on the prefix and postfix PTRS multiplexing criteria provided above.

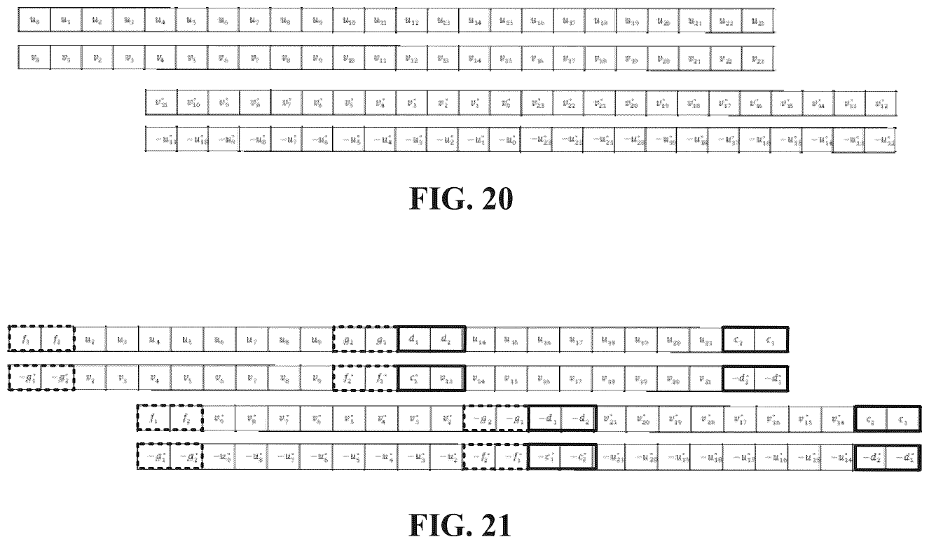

In an Example 6, M=24, m=12, K₁=2, K₂=2. FIG. 20 is a block diagram illustrating a j^{th} pair of input data blocks to a transmitter, after permutation, for Example 6, and FIG. 21 is a block diagram illustrating the j^{th} pair of input data blocks of Example 6 with multiplexed PTRS blocks.

As in other examples, comparisons between the drawings for Examples 5 and 6 reveal effects of different parameter values, including not only m, but also K₁ and K₂ in Examples 5 and 6.

Postfix PTRS blocks are added in Examples 5 and 6 such that the first set of PTRS blocks (denoted by f or g) in one data block are repeated in the first set of PTRS blocks of a next data block. With reference to FIGS. 19 and 21, for example, f₁ and f₂ appear at the beginning of the first data block and the next data block for transmission by Ant 1, and −g*₁ and −g*₂ appear at the beginning of the first data block and the next data block for transmission by Ant 2. Therefore, the first part of a next data block for transmission on each antenna port may be considered as being, or as providing an effect or feature of, a form of CP for a preceding data block.

As noted above for prefix PTRS, PTRS blocks for postfix PTRS are preferably the same for all data blocks. In the context of Examples 5 and 6, this means that all data blocks preferably use f and g for “postfix” PTRS. That way, the postfix PTRS in one data block act as a form of CP for a preceding data block. In other words, postfix PTRS blocks (f and g) are the same for all data blocks for transmission on a pair of antenna ports.

For postfix PTRS, there is a special case of the very last data block for transmission by an antenna port. A separate postfix may be used for that very first data block because there are no other data blocks after that data block. Therefore, the same postfix PTRS blocks (c and d) may be additionally added following the very last block.

PTRS Examples 1 to 6 illustrate transmitter inputs, with data and PTRS blocks multiplexed together. PTRS blocks are known to both a transmitter and a receiver. The implementation of PTRS as disclosed herein preserves STBC structure on PTRS blocks. Therefore, the receiver can use the PTRS blocks to estimate phase error and correct it. One approach to perform phase error correction is to do it at the output of the example receiver of FIG. 9, at 922, 924, 942, 944.

Regarding implementation, signaling may be exchanged between communication devices to enable a transmitting device to generate and transmit data multiplexed with a PTRS and/or to enable a receiving device to perform receiver processing to recover a PTRS and accurately estimate and correct for phase noise.

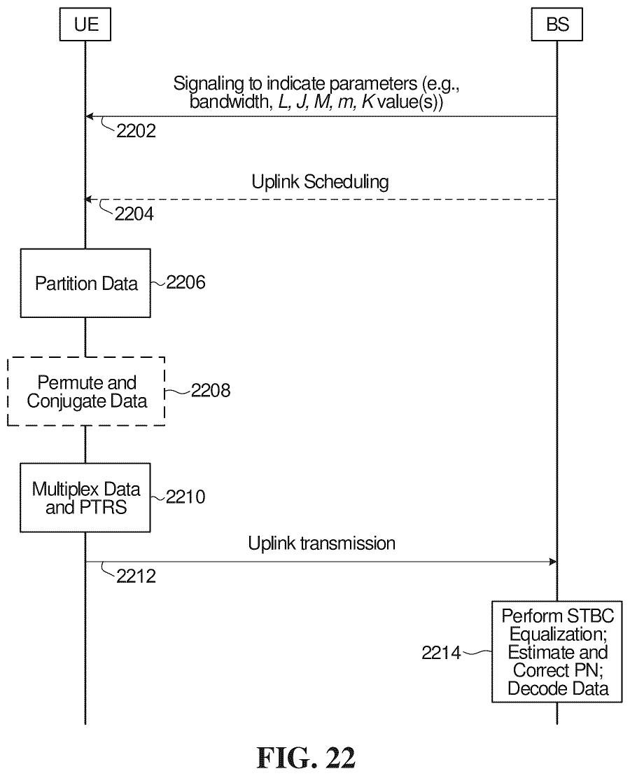

FIG. 22 is a signal flow diagram for uplink communications according to an embodiment. Features illustrated in FIG. 22 include communicating signaling at 2202, which may be higher layer signaling for example, between a first communication device and a second communication device in the form of a BS and a UE in the example shown. This communicating at 2202 involves transmitting the signaling by the BS to the UE and receiving the signaling by the UE from the BS. The signaling indicates parameters associated with partitioning data into data blocks and multiplexing a PTRS with the data blocks. The partitioning and multiplexing are such that pairs of the data blocks for transmission on respective antenna ports provide an STBC signal structure.

The STBC signal structure, consistent with features described elsewhere herein, includes a first data block (a data block u, for example) of a pair of data blocks for transmission on a first antenna port and a second data block (a data block v, for example) of the pair of data blocks for transmission on a second antenna port, a next data block for transmission on the first antenna port being related to the second data block of the pair of data blocks, and a next data block for transmission on the second antenna port being related to the first data block of the pair of data blocks. FIG. 8 illustrates one example of how a next data block for transmission on one antenna port may be related to a previous data block for transmission on another antenna port. The next data block as shown in FIG. 8 for transmission on antenna port Ant 1 is related to data block u by permutation and conjugation, and the next data block as shown in FIG. 8 for transmission on antenna port Ant 2 is related to data block u by negation, permutation, and conjugation.

Multiplexing of data and PTRS also maintains the STBC signal structure in accordance with disclosed embodiments. Thus, the STBC signal structure may also include a first block of the PTRS, such as block c in the upper blocks in FIGS. 11, 13, 15, and 17, at an end of each of the first data block and the next data block for transmission on the first antenna port, and a second block of the PTRS, such as the block related to d in the lower blocks in FIGS. 11, 13, 15, and 17, at an end of each of the second data block and the next data block for transmission on the second antenna port.

Pairs of data blocks as disclosed herein are also within a same phase noise interval for which the PTRS is usable to estimate phase noise. PTRS blocks that are multiplexed with data are close enough to each other in time domain that they do not encounter significantly different phase noise effects. As described elsewhere herein, this may be stated as each data block pair being within a time period over which phase noise is expected to remain constant, or at least sufficiently constant to allow the same phase noise estimate to be used for phase noise correction, or as the pairs being within the same phase noise bin.

Parameters indicated in or by the signaling at 2202 may include, for example, any one or more of: a length of an input data vector (L), a number of data blocks (2J in examples provided elsewhere herein) or pairs (J in FIG. 22) into which the data is to be partitioned, a length (M) of the data blocks, a PTRS length (K) that may be or include either or both of a length of the first block of the PTRS to be multiplexed with the data and a (possibly the same) length of the second block of the PTRS to be multiplexed with the data, and a parameter (m in FIG. 22) associated with a permutation that is related to the STBC signal structure.

In some examples herein, the first and second PTRS blocks are referred to as prefix PTRS. Postfix PTRS blocks may also or instead be multiplexed with data. In a prefix/postfix embodiment, for example, the STBC signal structure also includes a third block of the PTRS (f in the upper blocks in FIGS. 19 and 21, for example) at a beginning of each of the first data block and the next data block for transmission on the first antenna port, and a fourth block of the PTRS (related to g in the lower blocks in FIGS. 19 and 21, for example) at a beginning of each of the second data block and the next data block for transmission on the second antenna port. Parameters indicated in or by signaling in an embodiment that involves postfix PTRS may include, among other parameters disclosed herein, a PTRS length (K₂ for example) that may be or include either or both of a length of the third block of the PTRS to be multiplexed with the data and a (possibly the same) length of the fourth block of the PTRS to be multiplexed with the data. In a prefix/postfix embodiment, a length (K₁) of the first and second blocks of PTRS and a length (K₂) of the third and fourth blocks of PTRS are indicated in or by signaling. One or more length (K) values may be indicated in the signaling, as shown in FIG. 22.

Radio resource control (RRC) signaling is one example of signaling that may be used to indicate parameters, and possibly other information such as bandwidth in the example shown.

Some embodiments may involve a scheduling or grant procedure. Signaling related to uplink scheduling is optionally communicated between the BS and the UE at 2204, by the BS transmitting scheduling or grant signaling to the UE and the UE receiving the scheduling or grant signaling from the BS. This may involve, for example, downlink control information (DCI) scheduling of transmission of a transport block (TB) in uplink. Not all embodiments necessarily involve scheduling or grant procedures, and therefore uplink scheduling or grant signaling need not necessarily be communicated at 2204.

At a transmitter, data partitioning and multiplexing of data and PTRS may be performed as disclosed herein. At 2206, FIG. 22 illustrates data partitioning, and multiplexing of data and PTRS is shown at 2210. As described elsewhere herein, in an STBC signal structure data blocks for transmission on one antenna port are related to other data blocks for transmission by another antenna port, and examples of how such data blocks may be related to each other include negation, permutation, and conjugation. In FIG. 22, permutation and conjugation are shown by way of example at 2208. Transmit processing may include either or both of these operations, and/or others such as negation.

An uplink transmission from the UE to the BS is shown at 2212, and represents one example of how the data blocks, multiplexed with the PTRS, may be communicated by a communication device in a wireless communication network. In this example, communicating the data blocks multiplexed with the PTRS involves transmitting the data blocks multiplexed with the PTRS by the UE to the BS, and receiving the data blocks multiplexed with the PTRS by the BS from the UE.

At 2214, FIG. 22 illustrates the BS, as an example of a receiving communication device, performing STBC equalization, estimating and correcting phase noise using the PTRS, and decoding data.

FIG. 22, and other signal flow diagrams herein, illustrate only some operations or features that may be performed or supported at a transmitting device and a receiving device. A transmitting device and/or a receiving device, for example, may perform or support other features such as any of those disclosed elsewhere herein.

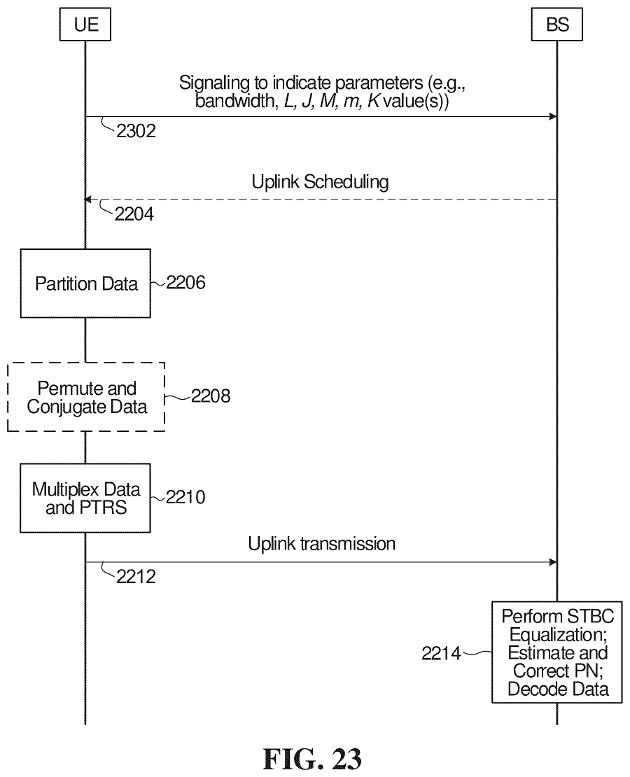

FIG. 23 is a signal flow diagram for uplink communications according to another embodiment. The example in FIG. 23 is similar to the example in FIG. 22, but involves communicating signaling at 2302 by transmitting the signaling by the UE to the BS and receiving the signaling by the BS from the UE. In some embodiments, uplink communications may involve the UE selecting or otherwise obtaining one or more parameters related to partitioning and multiplexing, and transmitting signaling that indicates such parameters, at 2302. From FIGS. 22 and 23, it is believed to be apparent that signaling may be communicated in either direction, or in both directions in other embodiments, from the UE to the BS and/or from the BS to the UE.

As an example of communicating signaling from the UE to the BS at 2302, consider an embodiment in which the UE obtains partitioning and multiplexing parameters. The UE may then transmit signaling at 2302 to indicate the parameters to the BS so that the BS can properly perform receiver processing.

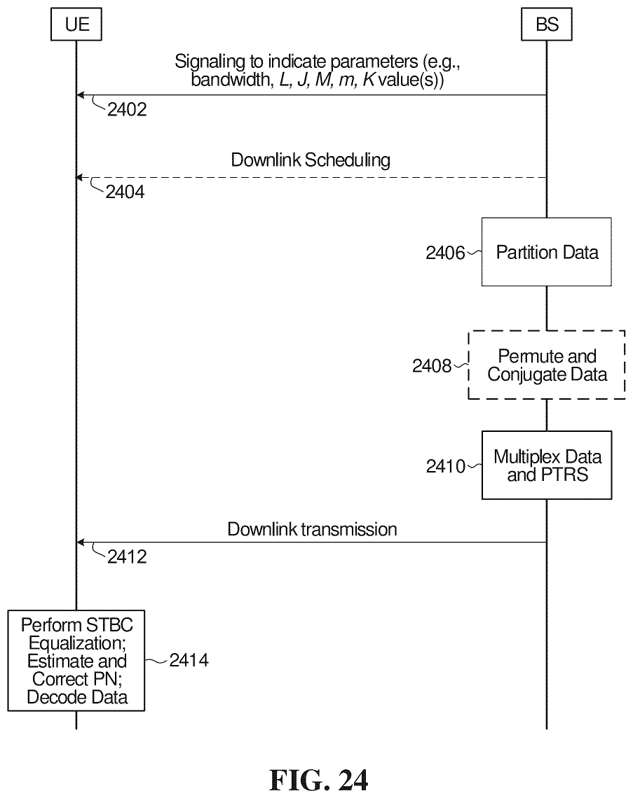

FIG. 24 is a signal flow diagram for downlink communications according to an embodiment. Features illustrated in FIG. 24 include communicating signaling at 2402, and optionally at 2404, between a BS and a UE. As in FIG. 22, this communicating at 2402, 2404 involves transmitting the signaling by the BS to the UE and receiving the signaling by the UE from the BS. The signaling at 2402 indicates parameters associated with partitioning and multiplexing, and the optional signaling at 2404 is related to optional scheduling or grant. In the case of downlink communications, scheduling or grant may involve, for example, DCI scheduling of transmission of a TB in downlink. As noted elsewhere herein, not all embodiments necessarily involve scheduling or grant procedures. Therefore, scheduling or grant signaling need not necessarily be communicated at 2404.

In the downlink example shown, partitioning and multiplexing are applied by the BS, at 2406, 2410. As in FIG. 22, permutation and conjugation are shown at 2408 as non-limiting examples of other operations that may be involved in transmit processing to provide an STBC signal structure.

A downlink transmission from the BS to the UE is shown at 2412, and represents another example of how data blocks multiplexed with a PTRS may be communicated in a wireless communication network. In this example, communicating the data blocks multiplexed with the PTRS involves transmitting the data blocks multiplexed with the PTRS by the BS to the UE and receiving the data blocks multiplexed with the PTRS by the UE from the BS. At 2414, FIG. 24 illustrates the UE performing STBC equalization, PN estimation and correction using the PTRS, and data decoding.

For downlink communications, it is likely that partitioning and multiplexing parameters will be selected or otherwise determined by the BS. However, it is possible that one or more parameters are obtained by the UE, transmitted by the UE to the BS, and received by the BS from the UE and used by the BS for downlink communications. Therefore, communicating signaling that indicates information associated with partitioning and multiplexing may involve communicating signaling from a UE to a BS, even in the case of downlink communications. In other words, similar to a discussion above with reference to FIGS. 22 and 23, for downlink communications signaling as shown at 2402 in FIG. 24 may be communicated in either or both directions, and involve transmitting the signaling by the UE and receiving the signaling by the BS, transmitting the signaling by the BS and receiving the signaling by the UE, or both transmitting signaling from the BS to the UE and transmitting signaling from the UE to the BS.

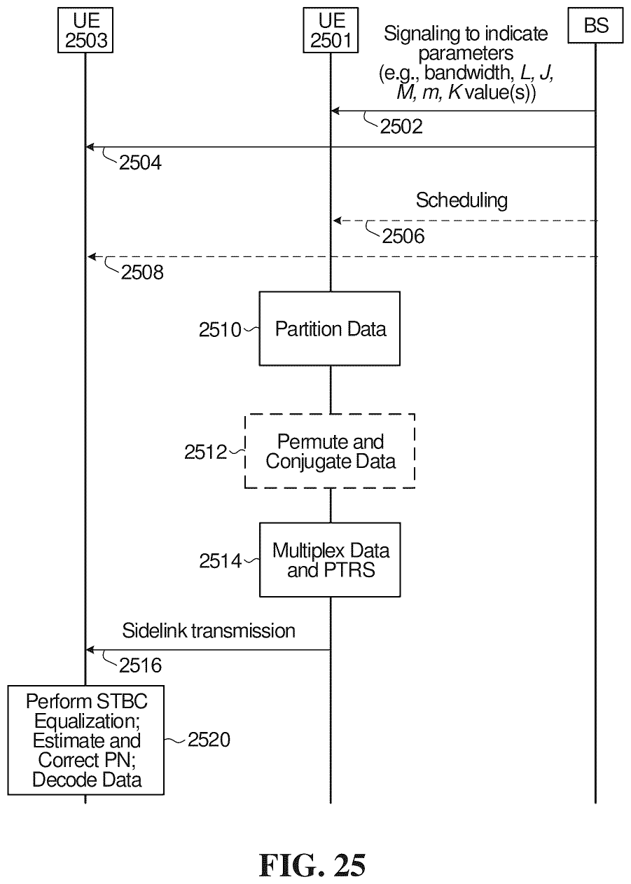

Uplink and downlink communications are described with reference to FIGS. 22 to 24. FIG. 25 is a signal flow diagram for sidelink communications according to an embodiment.

Sidelink transmission may occur between two UEs that may still be controlled by a BS. Features illustrated in FIG. 25 include communicating signaling at 2502, 2504, and optionally at 2506, 2508 between a BS and a first UE, UE 2501, and between the BS and a second UE, UE 2503. The communicating at 2502, 2506 involves transmitting the signaling by the BS to UE 2501 and receiving the signaling by UE 2501 from the BS. The communicating at 2504, 2508 involves transmitting the signaling by the BS to UE 2503 and receiving the signaling by UE 2503 from the BS. The signaling at 2502, 2504 indicates information associated with partitioning and multiplexing. The signaling at 2506, 2508 is optional signaling, related to scheduling or grant. As noted elsewhere herein, not all embodiments necessarily involve scheduling or grant procedures. Therefore, scheduling or grant signaling need not necessarily be communicated at 2506, 2508.

In sidelink, as in other embodiments, the partitioning and multiplexing, and possibly other operations such as permuting and/or conjugating, may be applied by a transmitting device. As shown at 2510, 2514, partitioning and multiplexing may be performed by the UE 2501, and permuting and conjugating are provided at 2512 as illustrative examples of other operations that may be involved in transmit processing.

A sidelink transmission between the UEs 2501, 2503 is shown at 2516, and represents another example of how data blocks multiplexed with a PTRS may be communicated in a wireless communication network. In this example, communicating the data blocks multiplexed with the PTRS involves transmitting the data blocks multiplexed with the PTRS by one UE 2501 to another UE 2503 and receiving the data blocks multiplexed with the PTRS by the UE 2503 from the UE 2501. At 2520, FIG. 25 illustrates the UE 2503 performing STBC equalization and PN estimation and correction using the PTRS, and decoding data.

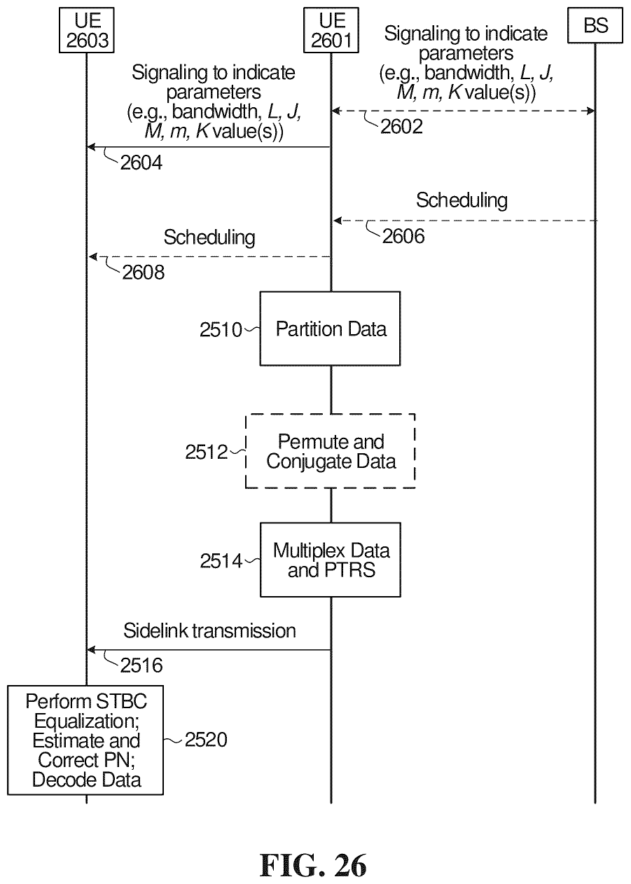

In another embodiment for sidelink communications, a transmitter UE such as UE 2501 configures one or more parameters for partitioning and multiplexing and sends signaling that indicates the parameter(s) to a receiving UE such as UE 2503, via sidelink control information (SCI) or PC5 (sidelink RRC). FIG. 26 is a signal flow diagram for sidelink communications according to another embodiment, which involves communicating signaling between a UE 2601 and a UE 2603.

The example in FIG. 26 involves communicating signaling that indicates at least parameters associated with partitioning and multiplexing (at 2604 and optionally at 2602), and possibly communicating signaling related to scheduling at 2606 and/or 2608. At 2604, 2608, communicating signaling involves transmitting signaling by UE 2601 to UE 2603 and receiving the signaling by UE 2603 from UE 2601. Sidelink communications may involve a transmitting UE (UE 2601 in FIG. 26) selecting or otherwise obtaining partitioning and multiplexing parameters for example, and transmitting signaling to a receiving UE (UE 2603 in FIG. 26).

Embodiments that involve communicating signaling between UEs as shown by way of example in FIG. 26 may or may not also involve communicating signaling between a BS and a UE. Optional features are shown in FIG. 26 at 2602, 2606. For sidelink communications, UE operations may remain transparent to the BS, and the BS need not be informed of parameters or communicate such parameters to UE 2601 at 2602, or communicate signaling for scheduling at 2606.

The other features shown in FIG. 26 may be substantially the same as in FIG. 25.

FIGS. 22 to 26 are illustrative of various embodiments. More generally, a method consistent with the present disclosure may involve communicating signaling between a first communication device and a second communication device in a wireless communication network. From the perspective of one of these communication devices, for example, such a method performed by a first (or second) communication device involves communicating signaling with a second (or first) communication device. The signaling indicates information associated with partitioning data into data blocks and multiplexing a PTRS with the data blocks.

Communicating signaling may involve transmitting the signaling, receiving the signaling, or both. Similarly, communicating data blocks multiplexed with the PTRS may involve transmitting the data multiplexed with the PTRS, receiving the data multiplexed with the PTRS, or both. For example, FIGS. 22 to 26 illustrate embodiments in which communicating signaling involves the following, any one or more of which may be provided or supported by different types of communication devices such as UEs or base stations:
receiving, by a UE, signaling from a BS or another UE, as shown by way of example at 2202, 2204, 2304, 2402, 2404, 2502, 2504, 2506, 2508, 2602, 2604, 2606, 2608;
receiving, by a BS, signaling from a UE, as shown by way of example at 2302, 2602;
transmitting, by a UE, signaling to a BS and/or to another UE, as shown by way of example at 2302, 2602, 2604, 2608;
transmitting, by a BS, signaling to one or more UEs, as shown by way of example at 2202, 2204, 2402, 2404, 2502, 2504, 2506, 2508, 2602, 2606.

These examples illustrate that communicating signaling may involve transmitting the signaling by any of various types of first communication device such as a UE or a base station or other network device, to any of various types of second communication device such as a UE or a base station or other network device. Communicating signaling may also or instead involve receiving the signaling at any of various types of first communication device such as a UE or a base station or other network device, from any of various types of second communication device such as a UE or a base station or other network device.

A method may also involve transmitting, by or from a first communication device or a second communication device for example, data blocks multiplexed with PTRS, as disclosed herein. Some embodiments involve receiving, by or at a second communication device or a first communication device for example, data blocks multiplexed with PTRS.

Similar to communicating signaling, communicating data blocks multiplexed with a PTRS may involve transmitting the data blocks multiplexed with the PTRS, by any of various types of communication device such as a UE or a base station or other network device, to any of various types of communication device such as a UE or a base station or other network device. Communicating data blocks multiplexed with a PTRS may also or instead involve receiving the data blocks multiplexed with the PTRS at any of various types of communication device such as a UE or a base station or other network device, from any of various types of communication device such as a UE or a base station or other network device. Examples of communicating a data block multiplexed with a PTRS, including transmitting and receiving examples, are shown in FIGS. 22 to 26 at 2212, 2412, 2616.

A receiver or intended receiver (or receiving device) of data blocks multiplexed with a PTRS may transmit or receive signaling before data blocks multiplexed with the PTRS is received. In FIG. 22, for example, the BS is the intended receiver and may transmit signaling at 2202, and optionally at 2204, before receiving the data blocks multiplexed with the PTRS at 2212. In FIG. 23, the BS is the intended receiver of the data blocks multiplexed with the PTRS and may receive signaling at 2302, and optionally transmit and/or receive signaling at 2304, before receiving the data blocks multiplexed with the PTRS at 2212. In FIG. 24, the UE is the intended receiver and may receive signaling at 2402, and optionally at 2404, before receiving the data blocks multiplexed with the PTRS at 2412. In FIGS. 25 and 26, UE 2503 or UE 2603 is the intended receiver of data blocks multiplexed with a PTRS and may receive signaling at 2504 and optionally at 2508 (from the BS) or at 2604 and optionally at 2608 (from UE 2601) before receiving data blocks multiplexed with the PTRS at 2516.

Similarly, a transmitter or intended transmitter (or transmitting device) of data blocks multiplexed with a PTRS may transmit or receive signaling before the data multiplexed with the PTRS is transmitted. In FIG. 22, for example, the UE is the transmitter of the data blocks multiplexed with the PTRS and may receive signaling at 2202 and optionally at 2204 before transmitting the data blocks multiplexed with the PTRS at 2212. The UE is also the transmitter of the data blocks multiplexed with the PTRS in FIG. 23, but may transmit signaling at 2302 and optionally transmit and/or receive signaling at 2304 before transmitting the data blocks multiplexed with the PTRS at 2212. In FIG. 24, the BS is the transmitter of the data blocks multiplexed with the PTRS and may transmit signaling at 2402 and optionally at 2404 before transmitting the data blocks multiplexed with the PTRS at 2412. In FIGS. 25 and 26, UE 2501 or UE 2601 is the transmitter of the data multiplexed with the PTRS and may receive signaling at 2502 and optionally 2506, 2602, 2606 (from the BS), or transmit signaling at 2604 and optionally at 2608 (to the UE 2603) and optionally at 2602 (to the BS) before transmitting the data blocks multiplexed with the PTRS at 2516.

In some embodiments, both signaling and data blocks multiplexed with the PTRS are communicated between a transmitter and an intended receiver of the data multiplexed with the PTRS, as in FIGS. 22 to 24 and between UE 2601 and UE 2603 in FIG. 26. Thus, in the context of communicating signaling between a first communication device and a second communication device, in such embodiments communicating the data blocks multiplexed with the PTRS involves communicating the data blocks multiplexed with the PTRS between the first communication device and the second communication device.

Signaling and data blocks multiplexed with a PTRS need not necessarily be communicated between the same devices. Consider FIG. 25 as an example. Signaling is communicated between the BS and UE 2501 at 2502 and between the BS and UE 2503 at 2504, but the data blocks multiplexed with the PTRS is communicated between UE 2501 and UE 2503 at 2516. This is illustrative of embodiments in which signaling and data blocks multiplexed with a PTRS are not communicated between the same devices. In the context of communicating signaling by a first communication device with a second communication device, in such embodiments communicating data blocks multiplexed with a PTRS may involve communicating the data blocks multiplexed with the PTRS by or from the first communication device (or the second communication device) and a third communication device in the wireless communication network.

These are all illustrative of examples of communicating signaling and communicating data blocks multiplexed with a PTRS.

These method examples are illustrative and non-limiting embodiments, and other embodiments may include additional or different features disclosed herein.

For example, any one or more of the following features may be provided, in any of various combinations:
the parameters include any one or more of: a number of the data blocks into which the data is to be partitioned, a length of the data blocks, a length of the first block of the PTRS to be multiplexed with the data, a length of the second block of the PTRS to be multiplexed with the data, and a parameter associated with a permutation that is related to the STBC signal structure;
the STBC signal structure further includes a third block of the PTRS at a beginning of each of the first data block and the next data block for transmission on the first antenna port, and a fourth block of the PTRS at a beginning of each of the second data block and the next data block for transmission on the second antenna port, in which case the parameters may include any one or more of: a number of the data blocks into which the data is to be partitioned, a length of the data blocks, a length of the first block of the PTRS to be multiplexed with the data, a length of the second block of the PTRS to be multiplexed with the data, a length of the third block of the PTRS to be multiplexed with the data, a length of the fourth block of the PTRS to be multiplexed with the data, and a parameter associated with a permutation that is related to the STBC signal structure;
the data includes an input symbol vector w to be partitioned into 2J data blocks, each of length M, such that w=[u(1), v(1), u(2), v(2), . . . , u(J), v(J)], where odd index blocks are denoted by u(j), j∈{1, . . . J} and even index blocks are denoted by v(j), j∈{1, . . . J }, and the STBC signal structure includes, for a j^{th} pair u(j), v(j) of the data blocks comprising u(j) as the first data block and v(j) as the second data block, the following for multiplexing with the PTRS and transmission on the first antenna port and the second antenna port, respectively:

u(j) Pₘv*(j)

$$v ( j ) - {P}_{m} {u}^{*} ( j )$$

where PₘV*(j) denotes the next data block for transmission on the first antenna port, PₘV*(j) denotes the next data block for transmission on the second antenna port, Pₘ(·) denotes a permutation matrix, and (·)* denotes a conjugate;
an n^{th} column of Pₘ is given by an [M−n+m−1]modM column of an identity matrix, where n, m∈{0,1 . . . , M−1} and [·]mod M notation denotes a modulo operation, and the n^{th} elements of Pₘu*(j) and Pₘv*(j) are u*_{[M-n+m-1]modM} and n, m∈{0,1 . . . , M−1} and v*_{[M-n+m-1]modM} and n, m∈{0,1 . . . , M−1}, respectively;
the data includes an input symbol vector w to be partitioned into 2J data blocks, each of length M, such that w=[u(1), v(1), u(2), v(2), . . . , u(J), v(J)], where odd index blocks are denoted by u(j), j∈{1, . . . , J } and even index blocks are denoted by v(j), j∈{1, . . . , J }, and the PTRS includes two PTRS blocks c and d of length K, to be multiplexed with a j^{th} pair u(j), v(j) of the data blocks comprising u(j) as the first data block and v(j) as the second data block, as follows:

$${u}_{m - 1 + r} = {d}_{r}$$

$${u}_{M - K + r} = {c}_{K - r}$$

$${v}_{m - 1 + r} = {c}_{r}^{*}$$

$${v}_{M - K + r} = - {d}_{K - r}^{*}$$

where cᵣ and dᵣ respectively denote r^{th} elements of c and d, r∈{1, . . . , K}, u and v denote u(j) and v(j), m is a parameter associated with a permutation that is related to the STBC signal structure, u_{M-K+r}=C_{K-r} denotes elements of the first block of the PTRS, and v_{M-K+r}=−d*_{K-r}, denotes elements of the second block of the PTRS;
the data includes an input symbol vector w to be partitioned into 2J data blocks, each of length M, such that w=[u(1), v(1), u(2), v(2), . . . , u(J), v(J)], where odd index blocks are denoted by u(j), j∈{1, . . . , J } and even index blocks are denoted by v(j), j∈{1, . . . , J}, and the PTRS includes two PTRS blocks c and d of length K₁ and two PTRS blocks f and g of length K₂, to be multiplexed with a j^{th} pair u(j), v(j) of the data blocks comprising u(j) as the first data block and v(j) as the second data block, as follows:

$${u}_{m - 1 + r} = {d}_{r}$$

$${u}_{M - {K}_{1} + r} = {c}_{{K}_{1} - r}$$

$${v}_{m - 1 + r} = {c}_{r}^{*}$$

$${v}_{M - {K}_{1} + r} = - {d}_{{K}_{1} - r}^{*}$$

$$and$$

$${u}_{m - {K}_{2} + r - 1} = {g}_{{K}_{2} + 1 - r}$$

$${u}_{r - 1} = {f}_{r}$$

$${v}_{m - {K}_{2} + r - 1} = {f}_{{K}_{2} + 1 - r}^{*}$$

$${v}_{r - 1} = - {g}_{r}^{*}$$

where c, and d, respectively denote r^{th} elements of c and d, with r∈{1, . . . , K₁}, fᵣ and gᵣ respectively denote r^{th} elements of f and g, with r∈{1, . . . , K₂}, u and v denote u(j) and v(j), m is a parameter associated with a permutation that is related to the STBC signal structure, u_{M-K}_{₁}₊ᵣ=c_{K}_{₁}₋ᵣ denotes elements of the first block of the PTRS, v_{M-K}_{₁}₊ᵣ=−d*_{K-r} denotes elements of the second block of the PTRS, uᵣ₋₁=fᵣ denotes elements of the third block of the PTRS, and vᵣ₋₁=−g*ᵣ denotes elements of the fourth block of the PTRS;
communicating the signaling involves transmitting the signaling by or from the first communication device to the second communication device;
communicating the signaling involves receiving the signaling by or at the second communication device from the first communication device;
communicating the signaling involves receiving the signaling by or at the first communication device from the second communication device;
communicating the signaling comprises transmitting the signaling by or from the second communication device to the first communication device;
transmitting the data blocks multiplexed with the PTRS involves transmitting the data blocks multiplexed with the PTRS by or from the first communication device to the second communication device;
transmitting the data blocks multiplexed with the PTRS involves transmitting the data blocks multiplexed with the PTRS by or from the first communication device to a third communication device in the wireless communication network;
receiving the data blocks multiplexed with the PTRS involves receiving the data blocks multiplexed with the PTRS by or at the second communication device from the first communication device;
receiving the data blocks multiplexed with the PTRS involves receiving the data blocks multiplexed with the PTRS by or at the second communication device from a third communication device in the wireless communication network.

Other embodiments are also possible.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

An apparatus may include a processor and a non-transitory computer readable storage medium, coupled to the processor, storing programming for execution by the processor. In FIG. 3, for example, the processors 210, 260, 276 may each be or include one or more processors, and each memory 208, 258, 278 is an example of a non-transitory computer readable storage medium, in an ED 110 and a TRP 170, 172. A non-transitory computer readable storage medium need not necessarily be provided only in combination with a processor, and may be provided separately in a computer program product, for example.

As an illustrative example, programming stored in or on a non-transitory computer readable storage medium may include instructions to or to cause a processor to communicate, by a first communication device with a second communication device in a wireless communication network for example, signaling that indicates parameters associated with partitioning data into data blocks and multiplexing a PTRS with the data blocks such that the data blocks include at least one pair of data blocks for transmission on respective antenna ports to provide an STBC signal structure as disclosed elsewhere herein; and transmit in the wireless communication network, by the first communication device for example, the data blocks multiplexed with the PTRS.

In another embodiment, programming stored in or on a non-transitory computer readable storage medium may include instructions to or to cause a processor to communicate such signaling with a first communication device in a wireless communication network, by a second communication device for example; and receive, by the second communication device for example, the data blocks multiplexed with the PTRS.

Embodiments related to apparatus or non-transitory computer readable storage media may include any one or more of the following features, for example, which are also discussed elsewhere herein:
the parameters include any one or more of: a number of the data blocks into which the data is to be partitioned, a length of the data blocks, a length of the first block of the PTRS to be multiplexed with the data, a length of the second block of the PTRS to be multiplexed with the data, and a parameter associated with a permutation that is related to the STBC signal structure;
the STBC signal structure further includes a third block of the PTRS at a beginning of each of the first data block and the next data block for transmission on the first antenna port, and a fourth block of the PTRS at a beginning of each of the second data block and the next data block for transmission on the second antenna port, in which case the parameters may include any one or more of: a number of the data blocks into which the data is to be partitioned, a length of the data blocks, a length of the first block of the PTRS to be multiplexed with the data, a length of the second block of the PTRS to be multiplexed with the data, a length of the third block of the PTRS to be multiplexed with the data, a length of the fourth block of the PTRS to be multiplexed with the data, and a parameter associated with a permutation that is related to the STBC signal structure;
the data includes an input symbol vector w to be partitioned into 2J data blocks, each of length M, such that w=[u(1), v(1), u(2), v(2), . . . , u(J), v(J)], where odd index blocks are denoted by u(j), j∈{1, . . . , J} and even index blocks are denoted by v(j), j∈{1, . . . , J}, and the STBC signal structure includes, for a j^{th} pair u(j), v(j) of the data blocks comprising u(j) as the first data block and v(j) as the second data block, the following for multiplexing with the PTRS and transmission on the first antenna port and the second antenna port, respectively:

u(j) Pₘv*(j)

$$v ( j ) - {P}_{m} {u}^{*} ( j )$$

where Pₘv*(j) denotes the next data block for transmission on the first antenna port, Pₘv*(j) denotes the next data block for transmission on the second antenna port, Pₘ(·) denotes a permutation matrix, and (·)* denotes a conjugate;
an n^{th} column of Pₘ is given by an [M−n+m−1]modM column of an identity matrix, where n, m∈{0,1 . . . , M−1} and [·]modM notation denotes a modulo operation, and the n^{th} elements of Pₘu*(j) and Pₘv*(j) are u*_{[M-n+m-1]}modM and n, m∈{0,1 . . . , M−1} and v*_{[M-n+m-1]modM} and n, m∈{0,1 . . . , M−1}, respectively;
the data includes an input symbol vector w to be partitioned into 2J data blocks, each of length M, such that w=[u(1), v(1), u(2), v(2), . . . , u(J), v(J)], where odd index blocks are denoted by u(j), j∈{1, . . . , J} and even index blocks are denoted by v(j), j∈{1, . . . , J}, and the PTRS includes two PTRS blocks c and d of length K, to be multiplexed with a j^{th} pair u(j), v(j) of the data blocks comprising u(j) as the first data block and v(j) as the second data block, as follows:

$${u}_{m - 1 + r} = {d}_{r}$$

$${u}_{M - K + r} = {c}_{K - r}$$

$${v}_{m - 1 + r} = {c}_{r}^{*}$$

$${v}_{M - K + r} = - {d}_{K - r}^{*}$$

where c, and d, respectively denote r^{th} elements of c and d, r∈{1, . . . , K}, u and v denote u(j) and v(j), m is a parameter associated with a permutation that is related to the STBC signal structure, u_{M-K+r}=c_{K-r} denotes elements of the first block of the PTRS, and v_{M-K+r}=−d*_{K-r} denotes elements of the second block of the PTRS;
the data includes an input symbol vector w to be partitioned into 2J data blocks, each of length M, such that w=[u(1), v(1), u(2), v(2), . . . , u(J), v(J)], where odd index blocks are denoted by u(j), j∈{1, . . . , J} and even index blocks are denoted by v(j), j∈{1, . . . , J}, and the PTRS includes two PTRS blocks c and d of length K₁ and two PTRS blocks f and g of length K₂, to be multiplexed with a j^{th} pair u(j), v(j) of the data blocks comprising u(j) as the first data block and v(j) as the second data block, as follows:

$${u}_{m - 1 + r} = {d}_{r}$$

$${u}_{M - {K}_{1} + r} = {c}_{{K}_{1} - r}$$

$${v}_{m - 1 + r} = {c}_{r}^{*}$$

$${v}_{M - {K}_{1} + r} = - {d}_{{K}_{1} - r}^{*}$$

$$and$$

$${u}_{m - {K}_{2} + r - 1} = {g}_{{K}_{2} + 1 - r}$$

$${u}_{r - 1} = {f}_{r}$$

$${v}_{m - {K}_{2} + r - 1} = {f}_{{K}_{2} + 1 - r}^{*}$$

$${v}_{r - 1} = - {g}_{r}^{*}$$

where cᵣ and dᵣ respectively denote r^{th} elements of c and d, with r∈{1, . . . , K₁}, fᵣ and gᵣ respectively denote r^{th} elements of f and g, with r∈{1, . . . , K₂}, u and v denote u(j) and v(j), m is a parameter associated with a permutation that is related to the STBC signal structure, u_{M-K}_{₁}₊ᵣ=c_{K}_{₁}₋ᵣ denotes elements of the first block of the PTRS, v_{M-K}_{₁}₊ᵣ=−d*_{K}_{₁}₋ᵣ denotes elements of the second block of the PTRS, uᵣ₋₁=fᵣ denotes elements of the third block of the PTRS, and vᵣ₋₁=−g* denotes elements of the fourth block of the PTRS;
the programming includes instructions to, or to cause a processor to, communicate the signaling by transmitting the signaling, by or from the first communication device for example, to the second communication device;
the programming includes instructions to, or to cause a processor to, communicate the signaling by receiving the signaling, by or at the second communication device for example, from the first communication device;
the programming includes instructions to, or to cause a processor to, communicate the signaling by receiving the signaling, by or at the first communication device for example, from the second communication device;
the programming includes instructions to, or to cause a processor to, communicate the signaling by transmitting the signaling, by or from the second communication device for example, to the first communication device;
the programming includes instructions to, or to cause a processor to, transmit the data blocks multiplexed with the PTRS, by or from the first communication device for example, to the second communication device;
the programming includes instructions to, or to cause a processor to, transmit the data blocks multiplexed with the PTRS, by or from the first communication device for example, to a further (third for example) communication device in the wireless communication network;
the programming includes instructions to, or to cause a processor to, receive the data blocks multiplexed with the PTRS, by or at the second communication device for example, from the first communication device;
the programming includes instructions to, or to cause a processor to, receive the data blocks multiplexed with the PTRS, by or at the second communication device for example, from a further (third for example) communication device in the wireless communication network.

Other embodiments are also possible. For example, a system may include an apparatus (or more than one apparatus) that is configured or otherwise operable to communicate signaling and transmit data blocks multiplexed with PTRS, and an apparatus (or more than one apparatus) that is configured or otherwise operable to communicate signaling and receive data blocks multiplexed with PTRS.

As another example, a method may involve communicating signaling as described elsewhere herein, and both transmitting, by a first communication device, data blocks multiplexed with PTRS, and receiving, by a second communication device, the data blocks multiplexed with the PTRS.

Data partitioning and PTRS multiplexing as disclosed herein my help retain the same or substantially the same PAPR of SC waveforms and provide transmit diversity. Data may be partitioned into blocks such that each block in a pair of data blocks encounters the same or substantially the same phase noise effect, or phase noise that is not substantially different. This may provide the ability to correct phase noise and perform well when phase noise is present.

A PTRS approach as disclosed herein, with STBC signal structure and properties, may enable a receiver to use STBC equalization and also use PTRS to estimate phase noise. Disclosed PTRS multiplexing of PTRS blocks as disclosed may also provide CP-type effects or features.

Although described primarily in the context of data and PTRS, embodiments disclosed herein may be applied to any reference signals that can be multiplexed with data, or even different reference signals that are multiplexed with each other.

Low PAPR may be of interest in different contexts or application scenarios, and accordingly embodiments disclosed herein may be used in any of various scenarios, including any of uplink, downlink, and sidelink communications in 5G cellular systems and beyond. Embodiments may also or instead be beneficial for application in satellite communications, WiFi systems, and/or other scenarios.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

For example, other embodiments may involve more than two antenna ports. For a general case of Nₜ antenna ports, partitioning and multiplexing as disclosed herein may be applied to pairs of antenna ports. With Nₜ/2 different pairs in this example, partitioning and multiplexing can be applied to provide STBC signal structure between the antenna ports of each pair, according to disclosed embodiments. In order to reduce or avoid interference between antenna port pairs, the pairs may be operated in different resources, such as at different times. Time division duplexing (TDD), for example, may be employed to orthogonalize antenna pairs. Another way to orthogonalize is to select the two best antenna ports according to channel measurements or statistics, and apply the disclosed approach to that pair of antenna ports.

Features disclosed herein in the context of method embodiments, for example, may also or instead be implemented in apparatus or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Although aspects of the present invention have been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

1. A method comprising:
communicating, by a first communication device with a second communication device in a wireless communication network, signaling that indicates parameters associated with partitioning data into data blocks and multiplexing a phase tracking reference signal (PTRS) with the data blocks such that the data blocks comprise at least one pair of data blocks for transmission on respective antenna ports to provide a space time block coding (STBC) signal structure, each pair of the at least one pair of data blocks comprising a first data block and a second data block,
the STBC signal structure comprising: the first data block for transmission on a first antenna port and the second data block for transmission on a second antenna port, a first next data block for transmission on the first antenna port being related to the second data block, and a second next data block for transmission on the second antenna port being related to the first data block,
the STBC signal structure further comprising: a first block of the PTRS at a first end of each of the first data block and the first next data block for transmission on the first antenna port, and a second block of the PTRS at a second end of each of the second data block and the second next data block for transmission on the second antenna port; and
transmitting, in the wireless communication network by the first communication device, the data blocks multiplexed with the PTRS.

2. The method of claim 1, the STBC signal structure further comprising: a third block of the PTRS at a first beginning of each of the first data block and the first next data block for transmission on the first antenna port, and a fourth block of the PTRS at a second beginning of each of the second data block and the second next data block for transmission on the second antenna port.

3. The method of claim 1, wherein the parameters comprise one or more of: a number of the data blocks into which the data is to be partitioned, a length of the data blocks, a first length of the first block of the PTRS, a second length of the second block of the PTRS, or a parameter associated with a permutation that is related to the STBC signal structure.

4. The method of claim 2, wherein the parameters comprise one or more of: a number of the data blocks into which the data is to be partitioned, a length of the data blocks, a first length of the first block of the PTRS, a second length of the second block of the PTRS, a third length of the third block of the PTRS, a fourth length of the fourth block of the PTRS, or a parameter associated with a permutation that is related to the STBC signal structure.

5. The method of claim 1, wherein:
the data comprises an input symbol vector w to be partitioned into 2J data blocks, each data block of length M, such that w=[u(1), v(1), u(2), v(2), . . . , u(J), v(J)], where odd index blocks are denoted by u(j), j∈{1, . . . , J}, and even index blocks are denoted by v(j), j∈{1, . . . , J}, and
the STBC signal structure comprises, for a j^{th} pair u(j), v(j) of the data blocks comprising u(j) as the first data block and v(j) as the second data block, following for multiplexing with the PTRS and transmission on the first antenna port and the second antenna port, respectively:
u(j) Pₘv*(j)
$$v ( j ) - {P}_{m} u * ( j )$$
where:
Pₘv*(j) denotes the first next data block for transmission on the first antenna port,
Pₘv*(j) denotes the second next data block for transmission on the second antenna port,
Pₘ(·) denotes a permutation matrix, and
(·)* denotes a conjugate.

6. A method comprising:
communicating, with a first communication device by a second communication device in a wireless communication network, signaling that indicates parameters associated with partitioning data into data blocks and multiplexing a phase tracking reference signal (PTRS) with the data blocks such that the data blocks comprise at least one pair of data blocks for transmission on respective antenna ports to provide a space time block coding (STBC) signal structure, each pair of the at least one pair of data blocks comprising a first data block and a second data block,
the STBC signal structure comprising: the first data block for transmission on a first antenna port and the second data block for transmission on a second antenna port, a first next data block for transmission on the first antenna port being related to the second data block, and a second next data block for transmission on the second antenna port being related to the first data block,
the STBC signal structure further comprising: a first block of the PTRS at a first end of each of the first data block and the first next data block for transmission on the first antenna port, and a second block of the PTRS at a second end of each of the second data block and the second next data block for transmission on the second antenna port; and
receiving, by the second communication device, the data blocks multiplexed with the PTRS.

7. The method of claim 6, the STBC signal structure further comprising: a third block of the PTRS at a first beginning of each of the first data block and the first next data block for transmission on the first antenna port, and a fourth block of the PTRS at a second beginning of each of the second data block and the second next data block for transmission on the second antenna port.

8. The method of claim 6, wherein the parameters comprise one or more of: a number of the data blocks into which the data is to be partitioned, a length of the data blocks, a first length of the first block of the PTRS, a second length of the second block of the PTRS, or a parameter associated with a permutation that is related to the STBC signal structure.

9. The method of claim 7, wherein the parameters comprise one or more of: a number of the data blocks into which the data is to be partitioned, a length of the data blocks, a first length of the first block of the PTRS, a second length of the second block of the PTRS, a third length of the third block of the PTRS, a fourth length of the fourth block of the PTRS, or a parameter associated with a permutation that is related to the STBC signal structure.

10. The method of claim 6, wherein:
the data comprises an input symbol vector w to be partitioned into 2J data blocks, each data block of length M, such that w=[u(1), v(1), u(2), v(2), . . . , u(J), v(J)], where odd index blocks are denoted by u(j), j∈{1, . . . , J}, and even index blocks are denoted by v(j), j∈{1, . . . , J}, and
the STBC signal structure comprises, for a j^{th} pair u(j), v(j) of the data blocks comprising u(j) as the first data block and v(j) as the second data block, following for multiplexing with the PTRS and transmission on the first antenna port and the second antenna port, respectively:
u(j) Pₘv*(j)
$$v ( j ) - {P}_{m} {u}^{*} ( j )$$
where:
Pₘv*(j) denotes the first next data block for transmission on the first antenna port,
Pₘv*(j) denotes the second next data block for transmission on the second antenna port,
Pₘ(·) denotes a permutation matrix, and
(·)* denotes a conjugate.

11. An apparatus comprising:
at least one processor; and
a non-transitory computer readable storage medium, coupled to the at least one processor, storing programming for execution by the at least one processor, the programming including instructions to cause the apparatus to:
communicate, with a second communication device in a wireless communication network, signaling that indicates parameters associated with partitioning data into data blocks and multiplexing a phase tracking reference signal (PTRS) with the data blocks such that the data blocks comprise at least one pair of data blocks for transmission on respective antenna ports to provide a space time block coding (STBC) signal structure, each pair of the at least one pair of data blocks comprising a first data block and a second data block; and
transmit, in the wireless communication network, the data blocks multiplexed with the PTRS,
the STBC signal structure comprising: the first data block for transmission on a first antenna port and the second data block for transmission on a second antenna port, a first next data block for transmission on the first antenna port being related to the second data block, and a second next data block for transmission on the second antenna port being related to the first data block,
the STBC signal structure further comprising: a first block of the PTRS at a first end of each of the first data block and the first next data block for transmission on the first antenna port, and a second block of the PTRS at a second end of each of the second data block and the second next data block for transmission on the second antenna port.

12. The apparatus of claim 11, the STBC signal structure further comprising: a third block of the PTRS at a first beginning of each of the first data block and the first next data block for transmission on the first antenna port, and a fourth block of the PTRS at a second beginning of each of the second data block and the second next data block for transmission on the second antenna port.

13. The apparatus of claim 11, wherein the parameters comprise one or more of: a number of the data blocks into which the data is to be partitioned, a length of the data blocks, a first length of the first block of the PTRS, a second length of the second block of the PTRS, or a parameter associated with a permutation that is related to the STBC signal structure.

14. The apparatus of claim 12, wherein the parameters comprise one or more of: a number of the data blocks into which the data is to be partitioned, a length of the data blocks, a first length of the first block of the PTRS, a second length of the second block of the PTRS, a third length of the third block of the PTRS, a fourth length of the fourth block of the PTRS, or a parameter associated with a permutation that is related to the STBC signal structure.

15. The apparatus of claim 11, wherein:
the data comprises an input symbol vector w to be partitioned into 2J data blocks, each data block of length M, such that w=[u(1), v(1), u(2), v(2), . . . , u(J), v(J)], where odd index blocks are denoted by u(j), j∈{1, . . . , J}, and even index blocks are denoted by v(j), j∈{1, . . . , J}, and
the STBC signal structure comprises, for a j^{th} pair u(j), v(j) of the data blocks comprising u(j) as the first data block and v(j) as the second data block, following for multiplexing with the PTRS and transmission on the first antenna port and the second antenna port, respectively:
u(j) Pₘv*(j)
$$v ( j ) - {P}_{m} {u}^{*} ( j )$$
where:
Pₘv*(j) denotes the first next data block for transmission on the first antenna port,
Pₘv*(j) denotes the second next data block for transmission on the second antenna port,
Pₘ(·) denotes a permutation matrix, and
(·)* denotes a conjugate.

16. An apparatus comprising:
at least one processor; and
a non-transitory computer readable storage medium, coupled to the at least one processor, storing programming for execution by the at least one processor, the programming including instructions to cause the apparatus to:
communicate, with a first communication device in a wireless communication network, signaling that indicates parameters associated with partitioning data into data blocks and multiplexing a phase tracking reference signal (PTRS) with the data blocks such that the data blocks comprise at least one pair of data blocks for transmission on respective antenna ports to provide a space time block coding (STBC) signal structure, each pair of the at least one pair of data blocks comprising a first data block and a second data block; and
receive the data blocks multiplexed with the PTRS,
the STBC signal structure comprising: the first data block for transmission on a first antenna port and the second data block for transmission on a second antenna port, a first next data block for transmission on the first antenna port being related to the second data block, and a second next data block for transmission on the second antenna port being related to the first data block,
the STBC signal structure further comprising: a first block of the PTRS at a first end of each of the first data block and the first next data block for transmission on the first antenna port, and a second block of the PTRS at a second end of each of the second data block and the second next data block for transmission on the second antenna port.

17. The apparatus of claim 16, the STBC signal structure further comprising: a third block of the PTRS at a first beginning of each of the first data block and the first next data block for transmission on the first antenna port, and a fourth block of the PTRS at a second beginning of each of the second data block and the second next data block for transmission on the second antenna port.

18. The apparatus of claim 16, wherein the parameters comprise one or more of: a number of the data blocks into which the data is to be partitioned, a length of the data blocks, a first length of the first block of the PTRS, a second length of the second block of the PTRS, or a parameter associated with a permutation that is related to the STBC signal structure.

19. The apparatus of claim 17, wherein the parameters comprise one or more of: a number of the data blocks into which the data is to be partitioned, a length of the data blocks, a first length of the first block of the PTRS, a second length of the second block of the PTRS, a third length of the third block of the PTRS, a fourth length of the fourth block of the PTRS, or a parameter associated with a permutation that is related to the STBC signal structure.

20. The apparatus of claim 16, wherein:
the data comprises an input symbol vector w to be partitioned into 2J data blocks, each data block of length M, such that w=[u(1), v(1), u(2), v(2), . . . , u(J), v(J)], where odd index blocks are denoted by u(j), j∈{1, . . . , J}, and even index blocks are denoted by v(j), j∈{1, . . . , J}, and
the STBC signal structure comprises, for a j^{th} pair u(j), v(j) of the data blocks comprising u(j) as the first data block and v(j) as the second data block, following for multiplexing with the PTRS and transmission on the first antenna port and the second antenna port, respectively:
u(j) Pₘv*(j)
$$v ( j ) - {P}_{m} {u}^{*} ( j )$$
where:
PₘV*(j) denotes the first next data block for transmission on the first antenna port,
Pₘv*(j) denotes the second next data block for transmission on the second antenna port,
Pₘ(·) denotes a permutation matrix, and
(·)* denotes a conjugate.
